(19) United States
(12) Patent Application Publication
(10) Pub. No.: US 2013/0203951 A1
(43) Pub. Date: Aug. 8, 2013

(54) GRAFT COPOLYMER, METHOD FOR THE PRODUCTION THEREOF, AND USE THEREOF

(71) Applicants: Roland Reichenbach-Klinke, Traunstein (DE); Johann Plank, Trostberg (DE); Peter Lange, Obing (DE); Gregor Keilhofer, Tacherting (DE)

(72) Inventors: Roland Reichenbach-Klinke, Traunstein (DE); Johann Plank, Trostberg (DE); Peter Lange, Obing (DE); Gregor Keilhofer, Tacherting (DE)

(73) Assignee: BASF SE, Ludwigshafen (DE)

(21) Appl. No.: 13/796,097

(22) Filed: Mar. 12, 2013

Related U.S. Application Data
(62) Division of application No. 12/990,346, filed on Dec. 7, 2010.

(51) Int. Cl. C08F 30/08

(52) U.S. Cl. CPC C08F 30/08
USPC 526/279

(57) ABSTRACT

A graft copolymer based on a component a) consisting of silica which has been reacted with an unsaturated silane, and a polymer component b) containing sulphonic acid is proposed. The silica used is preferably a nanosilica and the unsaturated silane is an ethylenically unsaturated alkoxysilane. The component b) is represented by a copolymer based on AMPS and a further ethylenically unsaturated monomer. The polymer according to the invention, which as a rule is a nanocomposite, is outstandingly suitable as an additive in construction chemistry applications and in the development, exploitation and completion of underground mineral oil and natural gas deposits, its effect as a water retention agent being particularly advantageous at high salinities and increased temperatures.

The present invention relates to a graft copolymer, a process for the preparation thereof and its use.

Copolymers, including those in grafted form, are sufficiently well known and, based on their specific monomer composition, are used in a very wide range of fields of use.

In the construction chemistry, copolymers are frequently also used as water retention agents, which are also referred to as fluid loss additives. A special field of use in this context is the cementing of wells in the development of underground mineral oil and natural gas deposits.

Fluid loss additives or water retention agents are understood as compounds which reduce the water released by a cement slurry. This is important in particular in the area of mineral oil and natural gas exploration since cement slurries, which substantially comprise cement and water, are pumped through the annular space between the so-called casing and the well wall during cementing. During this procedure, amounts of water may be released from the cement slurry to the subterranean formation. This is the case in particular when the cement slurry passes porous rock formations during well cementing. The alkalized water originating from the cement slurry may then cause clays to swell in the formations and to form calcium carbonate precipitates with carbon dioxide from the natural gas or mineral oil. As a result of these effects, the permeability of the deposits is reduced and as a result the production rates, too, are adversely affected.

In addition, as a result of the release of water to the porous subterranean formations, the cement slurry no longer solidifies homogeneously and is thus permeable to gases and to liquid hydrocarbons and water. Consequently, this leads to the escape of the fossil energy media through the annular space filled with porous cement.

Efforts have therefore long been made to reduce such water losses of the cement slurry used to a tolerable minimum.

EP 0 116 671 A1 stipulates, for example, a cement slurry for deep bores which, with its content of copolymers, is intended to reduce the water loss. Acrylamides and in particular acrylamidomethylpropanesulphonic acid (AMPS) form an important constituent of the copolymers used. According to this document, the cement slurries should contain between 0.1 and 3% by weight of the suitable copolymers.

EP 1 375 818 A1 is concerned with well cementing and a composition suitable for this purpose. A polymer additive which contains maleic acid, N-vinylcaprolactam and 4-hydroxybutyl vinyl ether in addition to AMPS is likewise used for fluid loss control.

A copolymer according to U.S. Pat. No. 4,015,991 is likewise based on AMPS or a hydrolyzed acrylamide. The copolymers described in this patent are likewise intended to improve the water retentivity in cement-containing compositions. The cementing of wells is mentioned as a primary field of use.

Polymers which are stable to hydrolytic influences and that also can be used in well cementing are described in U.S. Pat. No. 4,515,635. In the respective applications, the water loss is said to be reduced by the polymers described. The copolymers substantially comprise N,N-dimethylacrylamide and AMPS. Similar polymers are disclosed in U.S. Pat. No. 4,555,269. The copolymers described here have a specific ratio between the monomer components N,N-dimethylacrylamide and AMPS.

The US patents mentioned below also relate to compounds having water-retaining properties:

The water-soluble copolymers according to U.S. Pat. No. 6,395,853 B1 also contain, inter alia, the building blocks acrylamide and AMPS. Of primary importance in this patent is a process for reducing the water loss in a slurry which is used for the extraction of mineral oil. Well cementing and completion and the well slurry preceding these process steps are mentioned in particular in this context.

U.S. Pat. No. 4,700,780 focuses on a process for reducing the water loss in cement-containing compositions which also comprise defined salt concentrations. The water retention agent in turn is a polymer or polymer salt of AMPS, it also being necessary in this case for the building blocks styrene and acrylic acid to be present.

Finally, the U.S. Pat. No. 6,855,201 B2 discloses a cement composition which consists of a hydraulic cement component, water and a polymeric additive for fluid loss control. The copolymer is based on AMPS, the potassium salt of maleic acid, N-vinylcaprolactam and 4-hydroxybutyl vinyl ether. This polymer is added to the cement composition in amounts between 0.1 and 2% by weight.

Copolymers with inorganic and/or organic silicon compounds are likewise known:

The patent EP 043159 describes a carrier material for chromatography. This carrier material consists of inorganic, silanized particles to which a copolymer is covalently bonded. The inorganic particles are first reacted with a saturated alkoxysilane. Silanes mentioned are aminosilanes, mercaptosilanes, silanes containing ester groups and preferably glycidyloxysilanes. Various acrylamides can then be polymerized onto these silanized particles in the manner of an addition polymerization. Inter alia, AMPS is mentioned as a suitable acrylamide derivative.

The patent EP 0505230 describes silica particles in a polymer matrix with film-forming properties. Here too, the silica particles are first functionalized with a silane, but silanes containing double bonds are employed here. Various monomers are then polymerized onto these silanized silica particles. Alkyl(meth)acrylates, unsaturated monocarboxylic acids, aromatic vinyl compounds, dienes (butadiene, chloroprene), vinyl acetate and styrene are mentioned as monomers. In addition, polybasic, unsaturated carboxylic acids or unsaturated sulphonic acids (e.g. AMPS) may be present in proportions up to 15% by weight. The use of these film-forming polymers is limited to the paint industry.

A coating which consists of a monomer or oligomer curing by means of free radicals and a surface-treated inorganic particle is disclosed in WO 01/18082. The particle is coated with a fluorosilane and a crosslinkable silane, silanes containing double bonds also being mentioned as crosslinkable silanes. AMPS is mentioned as a suitable monomer.

Finally, DE 10 2005 000918 A1 describes a process for the preparation of an aqueous multicomponent dispersion. This dispersion is prepared by free radical polymerization of various monomers in the presence of inorganic particles and a dispersant. The monomer mixture contains at least one compound containing epoxide groups. Unsaturated silanes and sulphonic acids are also mentioned as additional monomers.

This multiplicity of known copolymers or graft polymers possesses, as has already herein been discussed briefly, a different property profile in each case with specific advantages and disadvantages, depending on their monomer composition. A general weakness which is peculiar to most of these polymers is that, with regard to their use in the construction chemistry sector, their fluid loss reducing effect declines in the presence of divalent salts, as also typically present in sea water which is frequently used for mixing the cement slurries in offshore oil and gas wells, and/or at very high temperatures above 190° Fahrenheit, a total loss of activity also being possible.

As just shown by way of example, intensive attempts have long been made to provide novel polymers whose water retentivity is stable in particular in the area of oil and gas exploration, so that an advantageous price/performance ratio may be assumed.

Since the salt stability as well as the temperature tolerance is still in need of improvement in specific applications, it is the object of the present invention to provide a novel graft copolymer which is based on tried and tested monomer building blocks but, through variation of the grafting partners, leads to a property profile which shows substantial improvements particularly in the presence of divalent salts and at very high temperatures.

This object was achieved by a water-soluble graft copolymer based on a component a) consisting of silica which has been reacted with an unsaturated silane and a water-soluble polymer component b) which contains sulphonic acid.

It has now surprisingly been found that this graft copolymer shows a substantially improved effect as a water retention agent, its advantages playing an important role in particular under demanding conditions. Owing to its monomer building blocks, this graft copolymer can be very economically prepared. Especially under saline conditions, it has been found that the fluid loss effect of the graft copolymers according to the invention has substantial advantages over the copolymers known to date.

Regarding the silica constituent in component a) it has proved to be advantageous in the present invention if this silica constituent is based on an aqueous colloidally disperse solution of amorphous silica (SiO₂). So-called nanosilica and microsilica have been found to be particularly suitable for the subsequent reaction with an unsaturated silane.

Nanosilicas are aqueous, colloidal solutions which only contain silica. The mean particle size of this silica is in the range between 5 and 500 nm, ranges between 15 and 100 nm and in particular between 30 and 70 nm being preferred.

Microsilica consists of particles having a size of 0.5 to about 100 μm. It includes, for example, pyrogenic silicas, precipitated silicas, furnace dusts and fly ashes.

The silane compound, which becomes part of the component a) by reaction with said silica, should, according to the invention, be an ethylenically unsaturated alkoxysilane. The number of carbon atoms should be between 5 and 15 in these alkoxysilanes. Members selected from the series 3-methacryloyloxypropyltrialkoxysilane, 3-methacryloyloxypropyldialkoxyalkylsilane, methacryloyloxymethyltrialkoxysilane, (methacryloyloxymethyl)dialkoxysilane, vinyldialkoxyalkylsilane and vinyltrialkoxysilane have been found to be particularly suitable. Silanes which initially have no double bond but can be converted into a silane containing a double bond by reaction with a suitable ethylenically unsaturated compound are also suitable. For example, the reaction product of aminopropyltrimethoxysilane and maleic anhydride is suitable here. It is also possible to adopt a stepwise procedure. The silica is first allowed to react with the aminosilane, whereupon reaction with maleic anhydride is then effected in the next step and finally polymerization is effected at the double bond.

In particular, copolymers of acrylamidomethylpropanesulphonic acid (AMPS) or vinylsulphonic acid with further ethylenically unsaturated monomers have been found to be suitable water-soluble polymer components b) containing sulphonic acid. Such monomers are preferably selected from the series consisting of the vinyl ethers, allyl ethers, acrylic acid, methacrylic acid, 2-ethylacrylic acid, 2-propylacrylic acid, vinylacetic acid, crotonic and isocrotonic acid, maleic acid, fumaric acid, itaconic acid, citraconic acid and the amides thereof. In general, styrenes, vinylphosphonic acid or ethylenically unsaturated silanes are also suitable. Polyethylenically unsaturated compounds such as, for example, ethylene glycol dimethacrylate, glyceryl dimethacrylate or trimethylolpropane trimethacrylate, may also be used. Unsaturated amide compounds, such as, for example, N-vinylformamide, N-vinylacetamide or acrylamide and derivatives thereof, have proved to be particularly preferred and here in particular N,N-dimethylacrylamide.

The variability with regard to the composition of the graft copolymer according to the invention is evident not only in the possibilities for choosing the monomers on which it is based but also in the mass ratio of the components a) and b) to one another. According to the present invention, this ratio may be preferably 10 to 1:1 to 10 and particularly preferably 5 to 1:1 to 5. It has also been found to be advantageous if the proportion of the component a), based on the graft copolymer, is 10 to 90% by weight and in particular 40 to 70% by weight. The proportion of the component b), based on the copolymer should be 10 to 90% by weight and, in particular, 30 to 60% by weight.

A variant of the graft copolymer according to the invention in which said copolymer is a nanocomposite is also to be regarded as being particularly advantageous. Here, the component b) should be covalently bonded to the surface of the silica via the silane.

Finally, the claimed graft copolymer may be present as a solid and in this case in particular as powder, but also as gel, colloid or suspension. A variant in which the copolymer has a proportion of 50 to 70% by weight of water is also included. Independently of the stated forms or suitable mixed forms thereof in which the copolymer is present, the average particle size thereof should be between 5 and 2000 nm and in particular between 50 and 1000 nm.

In addition to the polymer itself, the present invention also comprises a process for the preparation thereof which overall is very simple:

In process step a), the respective silica is reacted with the unsaturated silane and, in process stage b), the monomers of the component b) containing sulphonic acid are then grafted onto the silane reacted in this manner. The molar ratio of silica and silane in process step a) should be 200:1 to 20.

Sodium peroxodisulphate has proved to be particularly useful as an initiator of the polymerization reaction in process stage b). However, other usual initiators, such as peroxides, redox initiators or diazo compounds, are also suitable.

The process conditions are substantially non-critical. However, it has proved to be advantageous if the process steps a) and/or b) are carried out independently of one another at temperatures which are between 30 and 100° C. Temperatures between 60 und 75° are recommended for the process stage a), a temperature of about 70° C. being particularly suitable. For the process stage b), a temperature range between 40 und 60° C. should be chosen, temperatures of about 50° C. being particularly suitable in this case.

As already discussed, a particular feature with regard to the use of the graft copolymers according to the invention lies in construction chemicals applications. For this reason, the present invention also claims the use of the graft copolymer as an additive in construction chemistry applications and in particular in the development, exploitation and completion of underground mineral oil and natural gas deposits, its use as a water retention agent being regarded as particularly advantageous.

In summary, it may be stated that the proposed graft copolymers provide compounds which additionally improve the use of additives containing sulphonic acid in the construction chemicals sector. In particular owing to the salt tolerance and a significantly increased temperature stability in the region of ≧190° Fahrenheit, the graft copolymers according to the present invention are outstandingly suitable as water retention agents or fluid loss additives.

The following non-limiting examples illustrate these advantages.

### EXAMPLES

### 1) Preparation Example

131.6 g of Levasil® 50/50% (silica sol from H.C. Starck), 65.8 g of distilled H₂O and 5.6 g of methacryloyloxypropyltrimethoxysilane (Dynasylan MEMO from Degussa AG) were stirred for 30 min. During this time, the mixture thickened markedly and was therefore diluted with a further 65.8 g of water. The mixture was then heated for 4 h at 70° C. with stirring. After cooling to room temperature, a solution of 30 g AMPS, 20 g of DMA (N, N-Dimethylacrylamide) and 5.76 g of Ca(OH)₂ in 150 g of water was added. Thereafter the reaction mixture was flushed for 1 h with N₂; 2.28 g Na₂S₂O₈ were added as an initiator and heated to 50° C. After a reaction time of 1.5 h, the mixture was allowed to cool to room temperature (approximately 22° C.). A white gel having a solids content of 26.6% by weight was obtained.

### 2) Examples of Use

### Example of Use 2.1

The fluid loss was determined according to API standard 10A at 125° F. in the following slurry:
800 g of Class G Cement (Dyckerhoff Black Label)
352 g of distilled H₂O
1 ml of tributyl phosphate

| | Fluid |
|---|---|
| Fluid loss additive with dosage | loss [ml] |
| 1% bwoc of polymer according to preparation example 1 | 64 |
| (invention)) | |
| 0.4% bwoc of (AMPS/DMA copolymer + 0.6% bwoc of | 82 |
| Levasil ® 50/50%) (comparison) | |

The comparison of the nanocomposite according to the invention with a mixture of a standard AMPS/DMA copolymer and nanosilica, which corresponded to the ratios of copolymer and silica in the nanocomposite, shows that the fluid loss of the nanocomposite according to the invention is only insubstantially better than that of the comparative mixture at the relatively low measurement temperature.

### Example of Use 2.2

The fluid loss was determined according to API standard 10A at 190° F. in the following slurry:
800 g of Class G cement (Dyckerhoff Black Label)
352 g of distilled H₂O
1 ml of tributyl phosphate

| | Fluid |
|---|---|
| Fluid loss additive with dosage | loss [ml] |
| 1% bwoc of polymer according to preparation example 1 | 70 |
| (invention) | |
| 0.4% bwoc of (AMPS/DMA copolymer + 0.6% bwoc of | 180 |
| Levasil ® 50/50%) (comparison) | |

At the measurement temperature of 190° F., which is substantially higher compared with use example 2.1, substantial differences between the nanocomposite according to the invention and the comparative mixture are evident. While the fluid loss of the nanocomposite remains virtually constant compared with the measurement temperature of 125° F., the fluid loss of the mixture deteriorates significantly at 190° F. This means that the fluid loss behaviour of the nanocomposite according to the invention is temperature-independent.

### Example of Use 2.3

The fluid loss was determined according to API standard 10A at 125° F. in the following slurry:
800 g of Class G cement (Dyckerhoff Black Label)
352 g of distilled H₂O
14.1 g of sea salt

| | Fluid |
|---|---|
| Fluid loss additive with dosage | loss [ml] |
| 1% bwoc of polymer according to preparation example 1 | 120 |
| (invention) | |
| 0.4% bwoc of (AMPS/DMA copolymer + 0.6% bwoc of | 218 |
| Levasil ® 50/50%) (comparison) | |

Here too, substantial differences between the nanocomposite according to the invention and the comparative mixture again are found. Although the fluid loss of the nanocomposite also increases significantly as a result of the addition of sea salt, the fluid loss of the comparative mixture is about twice as high.

1-15. (canceled)

16. A process for the preparation of the graft copolymer, comprising reacting silica with an unsaturated silane and then grafting the monomers of a component b) containing sulphonic acid onto the silane, wherein the resultant graft copolymer is based on a component a) comprising the silica which has been reacted with the unsaturated silane and the water-soluble polymer component b) containing sulphonic acid.

17. A process according to claim 16, wherein the silica and the silane are provided in the molar ratio of 200:1 to 20 in process step a).

18. A process according to claim 16, wherein the reaction step or the grafting step are carried out independently of one another at temperatures of 30 to 100° C.

19. A process comprising adding the graft copolymer according to claim 16 as an additive in a composition for a construction chemistry application and in a composition employed in the development, exploitation or completion of underground mineral oil and natural gas deposits in an amount sufficient to provide a water retentive effect in said composition.

20. A process according to claim 16, wherein the silica of component a) is based on an aqueous colloidally disperse solution of amorphous silica.

21. A process according to claim 20, wherein the silica of component a) is a nanosilica.

22. A process according to claim 16, wherein the unsaturated silane is an ethylenically unsaturated alkoxysilane having 5 to 15 carbon atoms.

23. A process according to claim 16, wherein the unsaturated silane is selected from the group consisting of methacryloyloxypropyltrialkoxysilane, 3-methacryloyloxypropyldialkoxyalkylsilane, methacryloyloxymethyltrialkoxysilane, (methacryloyloxymethyl)dialkoxyalkylsilane, vinyldialkoxyalkylsilane and vinyltrialkoxysilane.

24. A process according to claim 16, wherein the water-soluble polymer is a copolymer of acrylamidomethylpropanesulphonic acid with a further ethylenically unsaturated monomer.

25. A process according to claim 21, wherein the unsaturated monomer is selected from the group consisting of vinyl ether, acrylic acid, methacrylic acid, 2-ethylacrylic acid, 2-propylacrylic acid, vinylacetic acid, crotonic and isocrotonic acid, maleic acid, fumaric acid, itaconic acid, citraconic acid, an amide of citraconic acid, styrenes, vinylphosphonic acid, an ethylenically unsaturated silane and a polyethylenically unsaturated compound.

26. A process according to claim 25, wherein the unsaturated monomer is selected from the group consisting of ethylene glycol dimethacrylate, glyceryl dimethacrylate and trimethylolpropane trimethacrylate.

27. A process according to claim 16, wherein the component b) contains an acrylamide compound.

28. A process according to claim 16, wherein component b) contains N, N-dimethylacrylamide.

29. A process according to claim 16, wherein the components a) and b) are in the mass ratio of 10 to 1:1 to 10.

30. A process according to claim 16, wherein the component a) is present in an amount of 10 to 90% by weight.

31. A process according to claim 16, wherein the component b) is present in an amount of 10 to 90% by weight.

32. A process according to claim 16, wherein the graft copolymer is a nanocomposite in which the component b) is covalently bonded to the surface of the silica via the silane.

33. A process according to claim 16, wherein the graft copolymer is a particulate which has an average particle size of between 5 and 2000 nm.

34. A process according to claim 16, wherein the graft copolymer is a solid.
